(19) United States
(12) Patent Application Publication
(10) Pub. No.: US 2018/0323482 A1
(43) Pub. Date: Nov. 8, 2018

(54) BATTERY WARMING-UP SYSTEM

(71) Applicant: DENSO CORPORATION, Kariya-city, Aichi-pref. (JP)

(72) Inventors: Koji MIURA, Kariya-city (JP); Takashi YAMANAKA, Kariya-city (JP); Yoshiki KATOH, Kariya-city (JP); Masayuki TAKEUCHI, Kariya-city (JP); Norihiko ENOMOTO, Kariya-city (JP); Keigo SATOU, Kariya-city (JP); Kengo SUGIMURA, Kariya-city (JP); Ariel MARASIGAN, Kariya-city (JP)

(21) Appl. No.: 15/773,209

(22) PCT Filed: Nov. 7, 2016
(86) PCT No.: PCT/JP2016/082943

§ 371 Date: May 3, 2018

(30) Foreign Application Priority Data
Nov. 9, 2015 (JP) 2015-219621
Oct. 4, 2016 (JP) 2016-196184

(51) Int. Cl. H01M 10/63; H01M 10/615; H01M 10/6563; H01M 10/6567

(52) U.S. Cl. CPC H01M 10/63; H01M 10/6567; H01M 10/6563; H01M 10/615

(57) ABSTRACT

A battery warming-up system includes a controller that controls an air-conditioning blower and a battery blower. A battery warming-up mode is executed to control at least one of the air-conditioning blower and the battery blower such that an air-side temperature efficiency in an air-conditioning heat exchanger is higher than an air-side temperature efficiency in a battery heat exchanger.

### CROSS REFERENCE TO RELATED APPLICATION

This application is based on Japanese Patent Applications No. 2015-219621 filed on Nov. 9, 2015, and No. 2016-196184 filed on Oct. 4, 2016, the contents of which are incorporated herein by reference in its entirety.

### FIELD OF THE INVENTION

The present disclosure relates to a battery warming-up system.

### BACKGROUND ART

A battery warming-up system is known to warm up a battery mounted on a vehicle mainly in an initial stage of start-up as described in Patent Document 1 described below. The battery warming-up system described in Patent Document 1 below is a refrigeration cycle device that adjusts the temperature of air to be sent out for warming up the battery, while also adjusting the temperature of air to be sent out into a space to be air-conditioned.

The refrigeration cycle device described in Patent Document 1 below includes a ventilation-air heat exchanger, a high-stage side expansion valve, and a battery heat exchanger. The ventilation-air heat exchanger heats an interior ventilation air to be blown into a vehicle interior by using a refrigerant discharged from a compression machine, as a heat source. The high-stage side expansion valve decompresses the refrigerant having flowed out of the ventilation-air heat exchanger. The battery heat exchanger heats a battery ventilation air to be blown at the battery by using the refrigerant decompressed by the high-stage side expansion valve, as a heat source. In an interior air-heating during an electric warming-up mode, the refrigeration cycle device controls a refrigerant discharge capacity of the compressor such that the ventilation air temperature of the interior ventilation air approaches a target blowing temperature. Further, the refrigeration cycle device also controls a throttle opening degree of the high-stage side expansion valve such that a battery temperature, which is the temperature of the battery, is within a predetermined reference temperature range.

### RELATED ART DOCUMENT

### Patent Document

[Patent Document 1] Japanese Unexamined Patent Application Publication No. 2014-37959

### SUMMARY OF INVENTION

In the technique described in Patent Document 1, in order to generate refrigerants with two different temperatures, the high-stage side expansion valve is provided between the ventilation-air heat exchanger and the battery heat exchanger. This arrangement cannot be achieved, for example, when adopting a system that includes a high-temperature side water circuit and a refrigerant circuit to supply, to both heat exchangers, the high-temperature water produced by exchanging heat in a water-cooled condenser provided in the refrigerant circuit.

Therefore, it is an object of the present disclosure to provide a battery warming-up system which can appropriately warm up a battery by having a high degree of flexibility in the form of supplying a refrigerant or a fluid to an air-conditioning heat exchanger and a battery heat exchanger.

In a present disclosure, a battery warming-up system includes: a compressor (112) that compresses and discharges a refrigerant; an air-conditioning heat exchanger (102) that heats an air-conditioning air flow to be sent to an air-conditioning space by using, as a heat source, a refrigerant discharged from the compressor or a fluid heat-exchanged with the refrigerant discharged from the compressor; a battery heat exchanger (103) that heats a battery air flow to be sent to a battery by using, as a heat source, a refrigerant discharged from the compressor or a fluid heat-exchanged with the refrigerant discharged from the compressor; an air-conditioning blower (106) that generates the air-conditioning air flow passing through the air-conditioning heat exchanger; a battery blower (107) that generates the battery air flow passing through the battery heat exchanger; and a controller (13) that controls the air-conditioning blower and the battery blower. The controller executes a battery warming-up mode of controlling at least one of the air-conditioning blower and the battery blower such that an air-side temperature efficiency in the air-conditioning heat exchanger is higher than an air-side temperature efficiency in the battery heat exchanger.

According to the present disclosure, the battery warming-up mode is executed so that the respective outlet temperatures at the air-conditioning heat exchanger and the battery heat exchanger can be changed while supplying fluids at the same temperature to these respective heat exchangers. Thus, both the air supply for the air-conditioning, which is intended to supply air at a higher temperature, and the air supply for the battery, which does not need air at such a high temperature, can be achieved.

### BRIEF DESCRIPTION OF DRAWINGS

FIG. 1 is a diagram showing a configuration of a battery warming-up system according to a first embodiment of the present invention;

FIG. 2 is a diagram showing an example in which the battery warming-up system according to the first embodiment of the present invention is mounted on a vehicle;

FIG. 3 shows timing charts of changes in the temperatures of respective components and in the wind speed when the battery warming-up system shown in FIG. 1 operates;

FIG. 4 is a diagram showing a configuration of a battery warming-up system according to a second embodiment of the present invention;

FIG. 5 shows timing charts of changes in the temperatures of respective components and in the wind speed when the battery warming-up system shown in FIG. 4 operates;

FIG. 6 is a diagram showing a configuration of a battery warming-up system according to a modification of the first embodiment in the present invention;

FIG. 7 is a diagram showing a configuration of a battery warming-up system according to another modification of the first embodiment in the present invention;

FIG. 8 is a diagram showing a configuration of a battery warming-up system according to another modification of the first embodiment in the present invention; and

FIG. 9 is a diagram showing a configuration of a battery warming-up system according to another modification of the first embodiment in the present invention.

### DESCRIPTION OF EMBODIMENTS

In the following, embodiments of the present invention will be described with reference to the accompanying drawings. For easy understanding of the description, the same components in respective drawings are denoted with the same reference characters as much as possible, and thus a redundant description thereof will be omitted below.

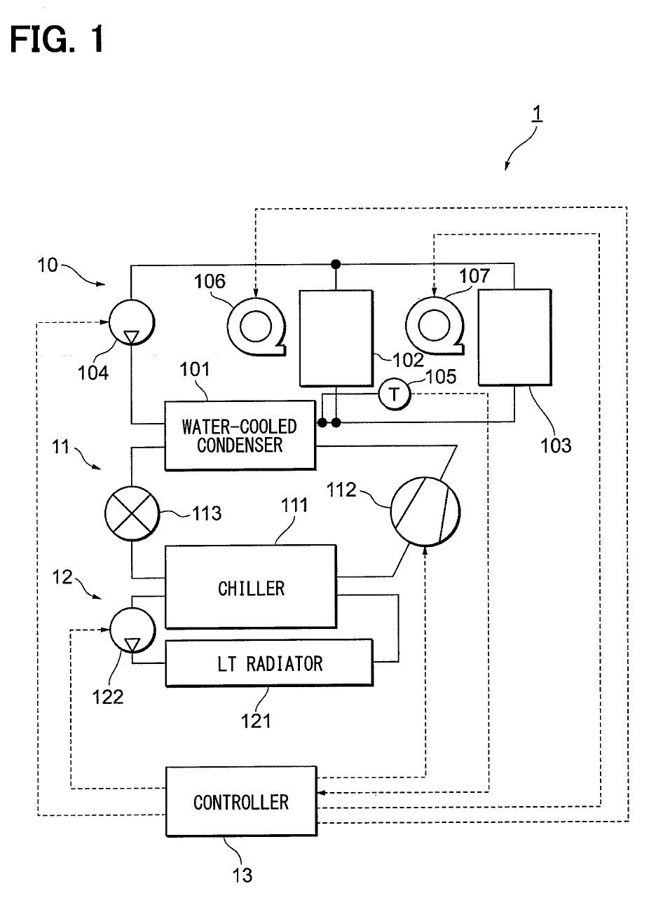

As shown in FIG. 1, a battery warming-up system 1 according to a first embodiment includes a high-temperature side water circuit 10, a refrigerant circuit 11, a low-temperature side water circuit 12, and a controller 13.

The high-temperature side water circuit 10 includes a water-cooled condenser 101, an air-conditioning heat exchanger 102, a battery heat exchanger 103, a pump 104, a water-temperature sensor 105, an air-conditioning blower 106, and a battery blower 107.

In the high-temperature side water circuit 10, warm water generated in the water-cooled condenser 101 is distributed into the air-conditioning heat exchanger 102 and the battery heat exchanger 103. The air-conditioning heat exchanger 102 and the battery heat exchanger 103 are disposed in parallel. The pump 104 is disposed on the upstream side with respect to the water-cooled condenser 101. The pump 104 is driven to allow the circulation of the water in the high-temperature side water circuit 10.

The water-temperature sensor 105 is a sensor that measures an outlet water temperature of the water-cooled condenser 101. The air-conditioning blower 106 sends air to the air-conditioning heat exchanger 102. The air sent to the air-conditioning heat exchanger 102 exchanges heat in the air-conditioning heat exchanger 102 to be sent to the vehicle interior. In the present embodiment, the air blowing volume of the air-conditioning blower 106 is adjusted to thereby regulate the temperature efficiency of the heat exchange in the air-conditioning heat exchanger 102. The air-conditioning heat exchanger 102 heats an air-conditioning air flow to be sent out to the space to be air-conditioned by using, as a heat source, a refrigerant discharged from a compressor as the compression machine or a fluid heat-exchanged with the refrigerant. In the temperature efficiencies in the air-conditioning heat exchanger 102, an air-side temperature efficiency η is determined by the following formula, where Ta_in is an air inlet temperature, Ta_out is an air outlet temperature, and Tw_in is a water inlet temperature. This relationship can apply to other heat exchangers and also to any refrigerant other than water.

η=(Ta_out−Ta_in)/(Tw_in−Ta_in)

The battery blower 107 sends air to the battery heat exchanger 103. The air sent to the battery heat exchanger 103 exchanges heat in the battery heat exchanger 103 to be sent into the battery. In the present embodiment, the air blowing volume of the battery blower 107 is adjusted to thereby regulate the temperature efficiencies of the heat exchange in the battery heat exchanger 103. The battery heat exchanger 103 heats a battery air flow to be sent out to the battery by using, as a heat source, a refrigerant discharged from the compressor as the compression machine or a fluid heat-exchanged with the refrigerant.

The refrigerant circuit 11 includes a chiller 111, a compressor 112, the water-cooled condenser 101, and an expansion valve 113. The high-temperature refrigerant pressure-fed by the compressor 112 as a compression machine, which serves to compress and discharge the refrigerant, exchanges heat with the water in the high-temperature side water circuit 10, at the water-cooled condenser 101. The refrigerant heat-exchanged in the water-cooled condenser 101 travels toward the chiller 111 via the expansion valve 113. The refrigerant exchanges heat with water flowing through the low-temperature side water circuit 12 in the chiller 111.

The low-temperature side water circuit 12 includes an LT radiator 121 as a heat-absorption heat exchanger, the chiller 111, and a pump 122. Water absorbing heat in the LT radiator 121 is sent to the chiller 111 by the pump 122 and exchanges heat with the refrigerant in the chiller 111.

The controller 13 outputs driving signals for respectively driving the pump 104, the air-conditioning blower 106, the battery blower 107, the compressor 112, and the pump 122. Information on the water temperature acquired by the water-temperature sensor 105 is output to the controller 13.

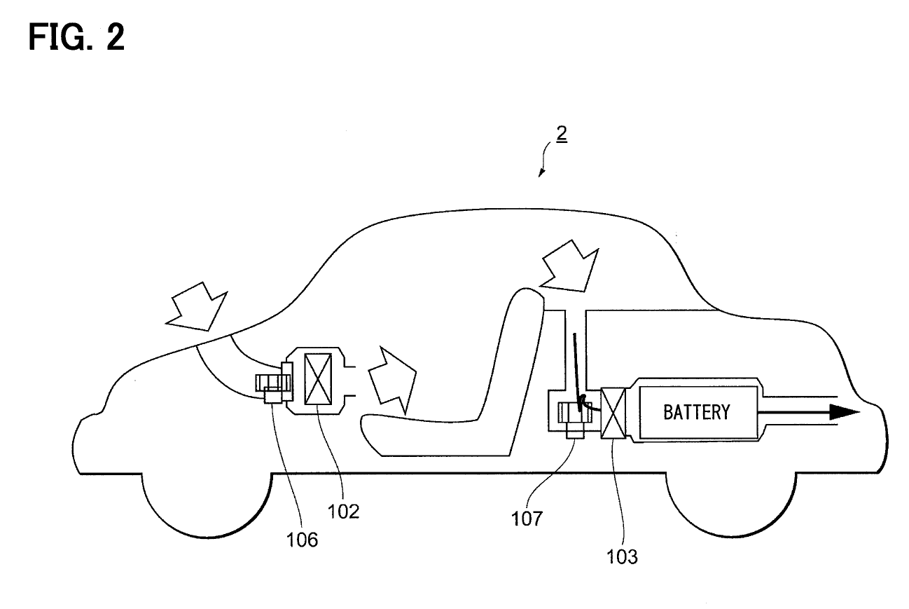

As shown in FIG. 2, the air-conditioning air flow sent by the air-conditioning blower 106 to the air-conditioning heat exchanger 102 is then sent as the battery air flow to the battery heat exchanger 103 by the battery blower 107. In the present embodiment, the air-conditioning blower 106 and the battery blower 107 in use are the so-called push-in blower, but one or both of them may be the so-called suction blower.

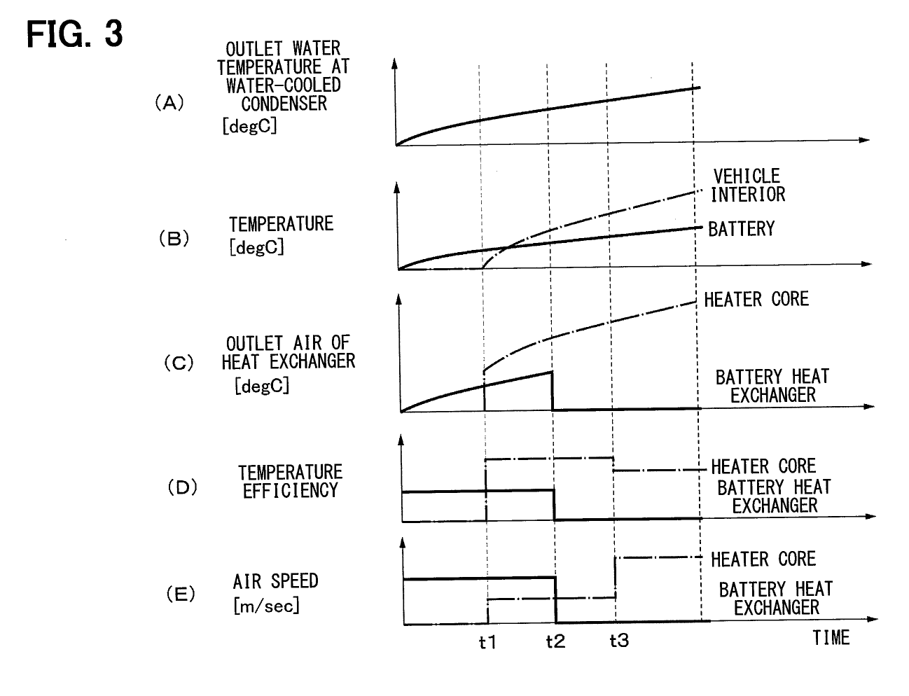

Subsequently, referring to FIG. 3, the control performed by the controller 13 will be described. When the battery warming-up system 1 starts to operate, the compressor 112 and the pumps 104 and 122 start being driven. As shown at (A) in FIG. 3, the outlet temperature at the water-cooled condenser 101 is gradually increased. In the initial stage of start-up, the temperature of the battery needs to be raised. The air temperature required for heating the vehicle interior is higher than the warming-up temperature required for warming-up the battery. For this reason, during a period of time when the outlet temperature at the water-cooled condenser 101 is not so high in the initial stage of start-up, heat is preferably used for warming-up the battery rather than for heating the vehicle interior.

In the present embodiment, as shown at (E) in FIG. 3, only the battery blower 107 is driven along with the start-up of the battery warming-up system 1. During a period of time from the initial stage of the start-up to a time t1, the heat exchange is performed only in the battery heat exchanger 103, so that as shown at (C) in FIG. 3, the outlet air temperature of the battery heat exchanger 103 increases, and as shown at (B) in FIG. 3, the temperature of the battery is also increased.

When the time t1 is reached, the outlet temperature at the water-cooled condenser 101 is further increased, and thereby the air-conditioning blower 106 is driven. Meanwhile, the temperature efficiency in the air-conditioning heat exchanger 102 is adjusted to be higher than the temperature efficiency in the battery heat exchanger 103. Thus, both the air supply for the air-conditioning, which is intended to supply air at a higher temperature, and the air supply for the battery, which does not need air at such a high temperature, can be achieved.

When a time t2 is reached, the battery warming-up is completed, and thereby the battery blower 107 is stopped. The completion of the battery warming-up refers to a state in which an output for traveling can be obtained from the battery, and the thermal insulating or warming-up effect can be obtained with self-generated heat due to the charge and discharge of the battery.

When the time t3 is reached, the outlet temperature at the water-cooled condenser 101 is further raised. At this time, the air speed of the air-conditioning blower 106 is further increased, and thereby the air with required temperature and volume can be supplied to the vehicle interior.

As mentioned above, the controller 13 in the first embodiment executes the battery warming-up mode to control the air-conditioning blower 106 and the battery blower 107 such that the air-side temperature efficiency in the air-conditioning heat exchanger 102 is higher than the air-side temperature efficiency in the battery heat exchanger 103. The battery warming-up mode is executed so that the outlet temperatures of the air-conditioning heat exchanger 102 and the battery heat exchanger 103 can be changed while supplying fluids at the same temperature to these respective heat exchangers. Thus, both the air supply for the air-conditioning, which is intended to supply air at a higher temperature, and the air supply for the battery, which does not need air at such a high temperature, can be achieved.

In the battery warming-up mode, the controller 13 adjusts the air blowing volume of at least one of the air-conditioning blower 106 and the battery blower 107 such that the air speed of the battery air flow passing through the battery heat exchanger 103 is higher than the air speed of the air-conditioning air flow passing through the air-conditioning heat exchanger 102. In general, if the inlet water temperature is equal to the inlet air temperature in the heat exchanger, the outlet air temperature is relatively reduced as the air speed becomes higher, while the outlet air temperature is relatively increased as the air speed becomes lower. The inlet water temperature of the air-conditioning heat exchanger 102 is substantially the same as the inlet water temperature of the battery heat exchanger 103. Therefore, an outlet air temperature of the battery heat exchanger 103 becomes lower than an outlet air temperature of the air-conditioning heat exchanger 102 when the air speed of the battery air flow passing through the battery heat exchanger 103 is adjusted to be higher than the air speed of the air-conditioning air flow passing through the air-conditioning heat exchanger 102. The air speed of the air-conditioning air flow passing through the air-conditioning heat exchanger 102 and the air speed of the battery air flow passing through the battery heat exchanger 103 may be set to any value that can make the temperature of the air-conditioning air flow higher than the temperature of the battery air flow. As mentioned above, for a period of time from the time t1 to the time t2, the blowers are driven such that the air speed of the air sent by the battery blower 107 is relatively higher than the air speed of the air sent by the air-conditioning blower 106. Consequently, the heat amount required for start-up of the battery can be supplied.

In the battery warming-up mode, the controller 13 drives the battery blower 107 from a stage in which the temperature of the refrigerant or fluid flowing through the battery heat exchanger 103 is lower than the temperature of the refrigerant or fluid flowing through the air-conditioning heat exchanger 102. As mentioned above, since the battery blower 107 is driven from a state in which the temperature of the refrigerant or water is low after the compressor 112 starts being driven, the battery warming-up can be completed quickly.

When the controller 13 executes the battery warming-up mode and determines that the battery reaches the target temperature, the controller 13 controls the battery blower 107 to reduce the air speed of the battery air flow passing through the battery heat exchanger 103. As mentioned above, when the battery warming-up mode is executed and the battery is determined to reach the target temperature, the battery air flow passing through the battery heat exchanger 103 has its air speed reduced and is eventually stopped. Consequently, a larger amount of heat can be used for the interior air conditioning without wasting heat for excess battery warming-up.

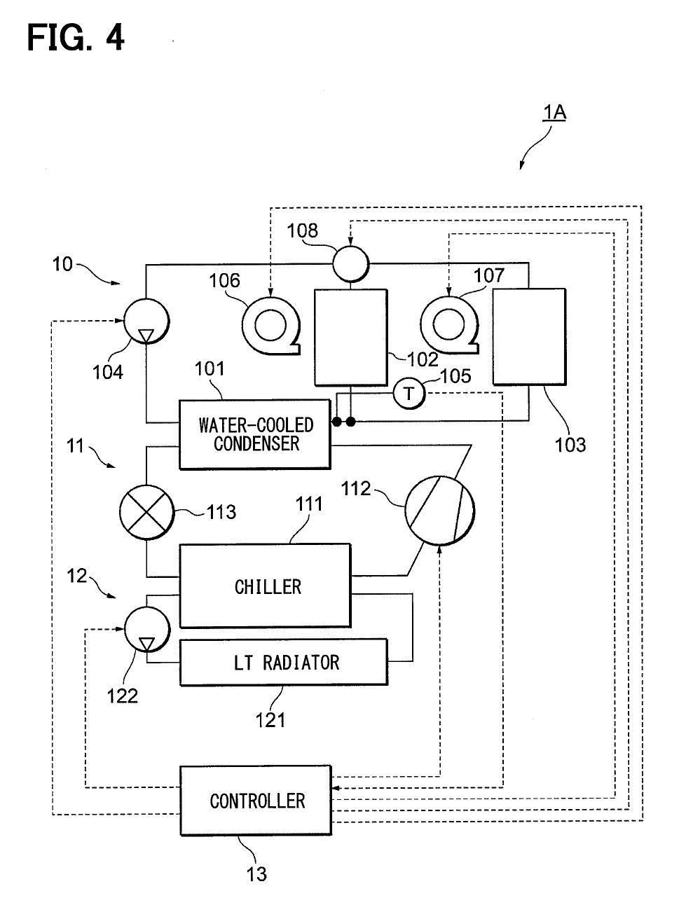

Subsequently, referring to FIG. 4, a battery warming-up system 1A according to a second embodiment will be described. The battery warming-up system 1A is configured by adding a three-way valve 108 to the high-temperature side water circuit 10 in the battery warming-up system 1 according to the first embodiment. The controller 13 controls an opening degree of the three-way valve 108, thereby making it possible to adjust the amount of water flowing into the air-conditioning heat exchanger 102 and the amount of water flowing into the battery heat exchanger 103.

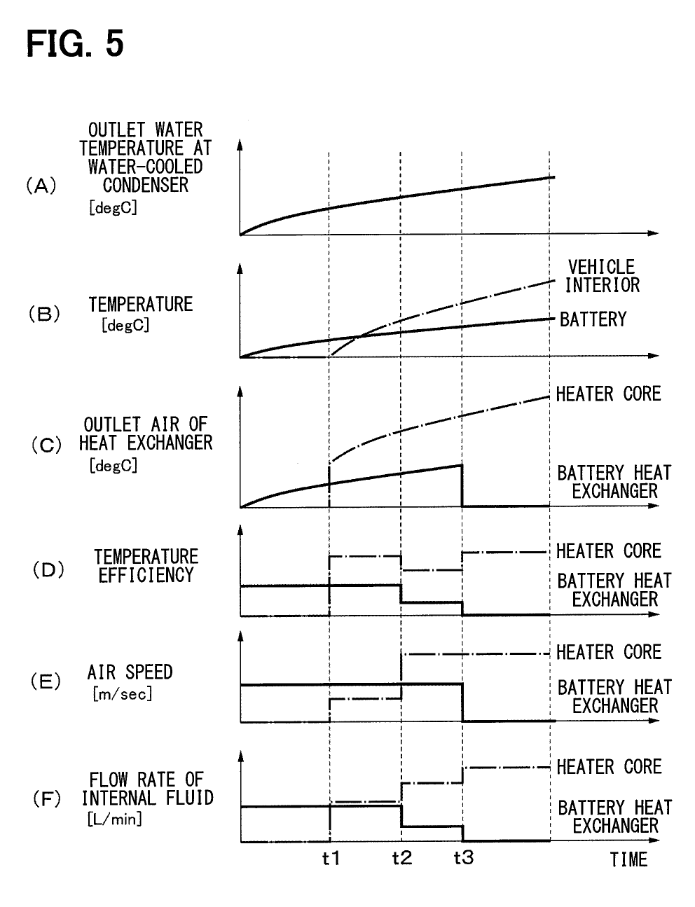

Subsequently, referring to FIG. 5, the control performed by the controller 13 according to the second embodiment will be described. When the battery warming-up system 1A starts to operate, the compressor 112 and the pumps 104 and 122 start being driven. As shown at (A) in FIG. 5, the outlet temperature at the water-cooled condenser 101 is gradually increased. In the initial stage of start-up, the temperature of the battery needs to be raised. The air temperature required for heating the vehicle interior is higher than the warming-up temperature required for warming-up the battery. For this reason, during a period of time when the outlet temperature at the water-cooled condenser 101 is not so high in the initial stage of start-up, heat is preferably used for warming-up the battery rather than for heating the vehicle interior.

In the present embodiment, as shown at (E) in FIG. 5, only the battery blower 107 is driven along with the start-up of the battery warming-up system 1A. Further, the three-way valve 108 is adjusted to control water to cause the water to flow only into the battery heat exchanger 103. In a period of time from the initial stage of the start-up to a time t1, the heat exchange is performed only in the battery heat exchanger 103, so that as shown at (C) in FIG. 5, the outlet air temperature at the battery heat exchanger 103 increases, and as shown at (B) in FIG. 5, the temperature of the battery also increases.

When the time t1 is reached, the outlet temperature at the water-cooled condenser 101 is further increased, and thereby the air-conditioning blower 106 is driven. Further, the three-way valve 108 is adjusted to control water to cause the water to flow into the battery heat exchanger 103 and the air-conditioning heat exchanger 102. The temperature efficiency in the air-conditioning heat exchanger 102 is adjusted to be higher than the temperature efficiency in the battery heat exchanger 103. For a period of time from the time t1 to the time t2, the battery blower 107 is driven such that the air speed of the air sent by the battery blower 107 is relatively higher than the air speed of the air sent by the air-conditioning blower 106. Consequently, the heat required for start-up of the battery can be supplied. Further, for the period of time from the time t1 to the time t2, the amount of water flowing into the air-conditioning heat exchanger 102 is controlled to be more than the amount of water flowing into the battery heat exchanger 103. In general, if the inlet water temperature is equal to the inlet air temperature in the heat exchanger, the outlet air temperature is relatively increased as the flow rate of water increases, while the outlet air temperature is relatively reduced as the flow rate of water decreases. Therefore, for the period of time from the time t1 to the time t2, the temperature efficiency in the air-conditioning heat exchanger 102 is adjusted to be higher than the temperature efficiency in the battery heat exchanger 103 from the viewpoint of the adjustment of the air speed and the adjustment of the water amount. Thus, both the air supply for the air-conditioning, which is intended to supply air at a higher temperature, and the air supply for the battery, which does not need air at such a high temperature, can be achieved.

When the time t2 is reached, the number of revolutions of the air-conditioning blower 106 is increased so as to increase the amount of air sent from the air-conditioning blower 106. The three-way valve 108 is adjusted to decrease the amount of water flowing into the battery heat exchanger 103 and to decrease the amount of water flowing into the air-conditioning heat exchanger 102.

When a time t3 is reached, the battery warming-up is completed. Therefore, at this time, the battery blower 107 is stopped, and the supply of water to the battery heat exchanger 103 is also stopped. The completion of the battery warming-up refers to a state in which an output for traveling can be obtained from the battery, and the thermal insulating or warming-up effect can be obtained with self-generated heat due to the charge and discharge of the battery. When the time t3 is reached, the outlet temperature at the water-cooled condenser 101 is further raised, and therefore, the amount of water flowing into the air-conditioning heat exchanger 102 is further increased, thereby making it possible to supply the required volume of the air at the required temperature to the vehicle interior.

In the above-mentioned second embodiment, the three-way valve 108 is provided to serve as an air-conditioning adjustment portion for adjusting the amount of refrigerant or fluid flowing to the air-conditioning heat exchanger 102 and as a battery adjustment portion for adjusting the amount of refrigerant or fluid flowing to the battery heat exchanger 103. The controller 13 is configured to control the air-conditioning blower 106, the battery blower 107, and the three-way valve 108. The controller 13 executes the battery warming-up mode to control at least one of the air-conditioning blower 106, the battery blower 107, and the three-way valve 108 such that the air-side temperature efficiency in the air-conditioning heat exchanger 102 is higher than the air-side temperature efficiency in the battery heat exchanger 103.

In addition or instead of the adjustment of the volume of air to be sent to each of the air-conditioning heat exchanger 102 and the battery heat exchanger 103, the amount of water to be sent to each of the air-conditioning heat exchanger 102 and the battery heat exchanger 103 is also adjusted, thereby making it possible to use the heat more efficiently.

In the second embodiment, the controller 13 adjusts the three-way valve 108 in the battery warming-up mode such that the amount of refrigerant or fluid sent to the battery heat exchanger 103 is smaller than the amount of refrigerant or fluid sent to the air-conditioning heat exchanger 102. The adjustment of the three-way valve 108 corresponds to the adjustment of the sending amount of at least one of the air-conditioning adjustment portion and the battery adjustment portion in the present invention. In the second embodiment, the three-way valve 108 is adjusted such that for a period of time from the time t1 to the time t2 and for a period of time from the time t2 to the time t3, the amount of water sent to the battery heat exchanger 103 is smaller than the amount of water sent to the air-conditioning heat exchanger 102. Thus, by adjusting the sending amount of water in this way, both the air supply for the air-conditioning, which is intended to supply air at a higher temperature, and the air supply for the battery, which does not need air at such a high temperature, can be achieved.

In the second embodiment, the controller 13 controls at least one of the air-conditioning blower 106, the battery blower 107, and the three-way valve 108 in the battery warming-up mode such that the battery heat exchanger 103 starts to perform heat exchange from a stage in which the temperature of the refrigerant or fluid flowing to the battery heat exchanger 103 is lower than the temperature of the refrigerant or fluid flowing to the air-conditioning heat exchanger 102. Since water is supplied to the battery heat exchanger 103 while driving the battery blower 107 from a state in which the temperature of the refrigerant or water is low after the compressor 112 starts being driven, the battery warming-up can be completed quickly.

In the second embodiment, when the controller 13 executes the battery warming-up mode and determines that the battery reaches the target temperature, the controller 13 executes one or both of a control operation of controlling the battery blower 107 to reduce the air speed of the battery air passing through the battery heat exchanger 103 and a control operation of controlling the three-way valve 108 to lessen the amount of refrigerant or fluid sent to the battery heat exchanger 103. When the battery warming-up mode is executed and the battery is determined to reach the target temperature, the battery air passing through the battery heat exchanger 103 has its air speed reduced and is stopped. In addition, since the supply of water to the battery heat exchanger 103 is stopped, a larger amount of heat can be used for the interior air conditioning without wasting heat for excess battery warming-up.

In the above-mentioned first embodiment and second embodiment, the controller 13 executes the battery warming-up mode when the discharge from the battery is started. When the battery warming-up system 1, 1A is mounted on the vehicle, the case in which the discharge from the battery is started corresponds to a case in which an ignition switch is turned on.

In the above-mentioned first embodiment and second embodiment, the controller 13 executes the battery warming-up mode when the temperature of the refrigerant or fluid is higher than the temperature of the battery. This is because, if the air with even a slightly higher temperature than the temperature of the battery temperature can be supplied, the startability of the battery is improved.

In the above-mentioned first embodiment and second embodiment, the fluid is high-temperature water heat-exchanged in the water-cooled condenser 101, which is a water-refrigerant heat exchanger in the refrigeration cycle. The air-conditioning heat exchanger 102 and the battery heat exchanger 103 are arranged in parallel. By arranging the air-conditioning heat exchanger 102 and the battery heat exchanger 103 in parallel, the three-way valve 108 can be provided like the second embodiment, thereby making it possible to adjust the amounts of water respectively supplied to the air-conditioning heat exchanger 102 and the battery heat exchanger 103.

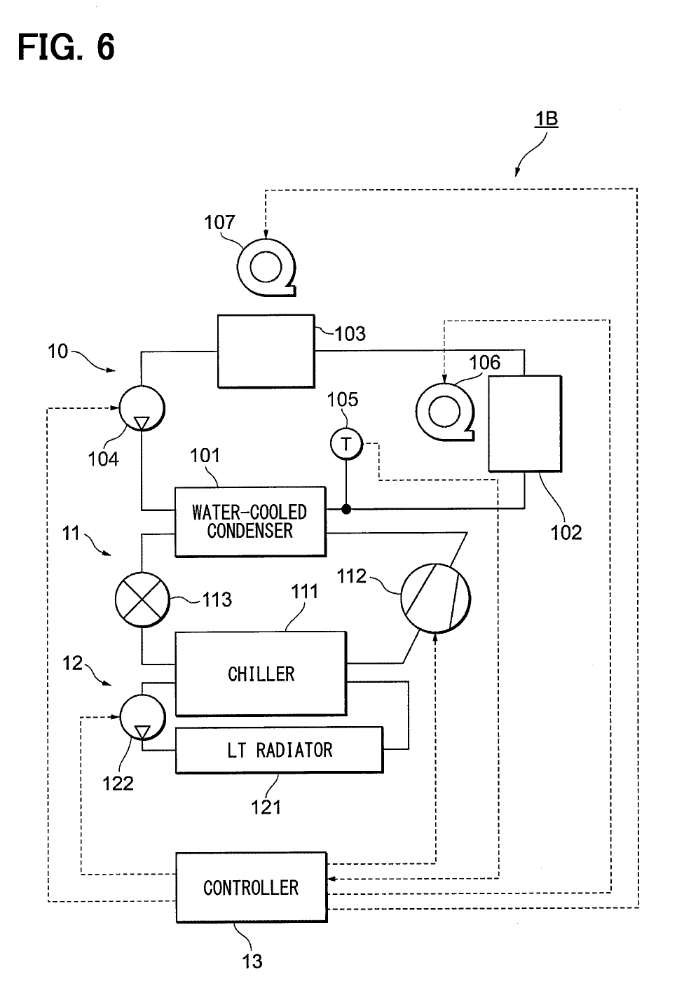

Alternatively, while the fluid is the high-temperature water heat-exchanged in the water-cooled condenser 101 as the water-refrigerant heat exchanger in the refrigeration cycle likewise, the water-cooled condenser 101, the air-conditioning heat exchanger 102, and the battery heat exchanger 103 can also be arranged in series from the upstream side, through which the fluid flows, in this order, like a modification shown in FIG. 6. Such a series arrangement can eliminate branch parts in the flow path. Further, the air-conditioning heat exchanger 102 is disposed on the upstream side, and the battery heat exchanger 103 is disposed on the downstream side. Thus, the water at a higher temperature can be supplied to the air-conditioning heat exchanger 102, and the water at a lower temperature, which is suitable for warming up the battery, can be supplied to the battery heat exchanger 103.

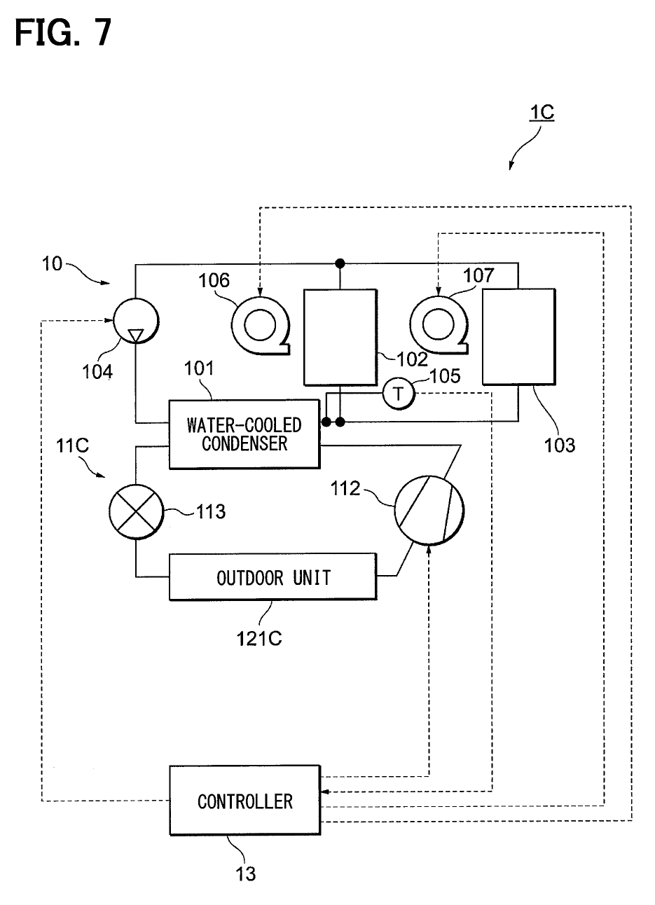

As shown in FIG. 7, an outdoor unit 121C can also be provided in a refrigerant circuit 11C. Since the outdoor unit 121C can directly absorb heat, the low-temperature side water circuit 12 can be omitted.

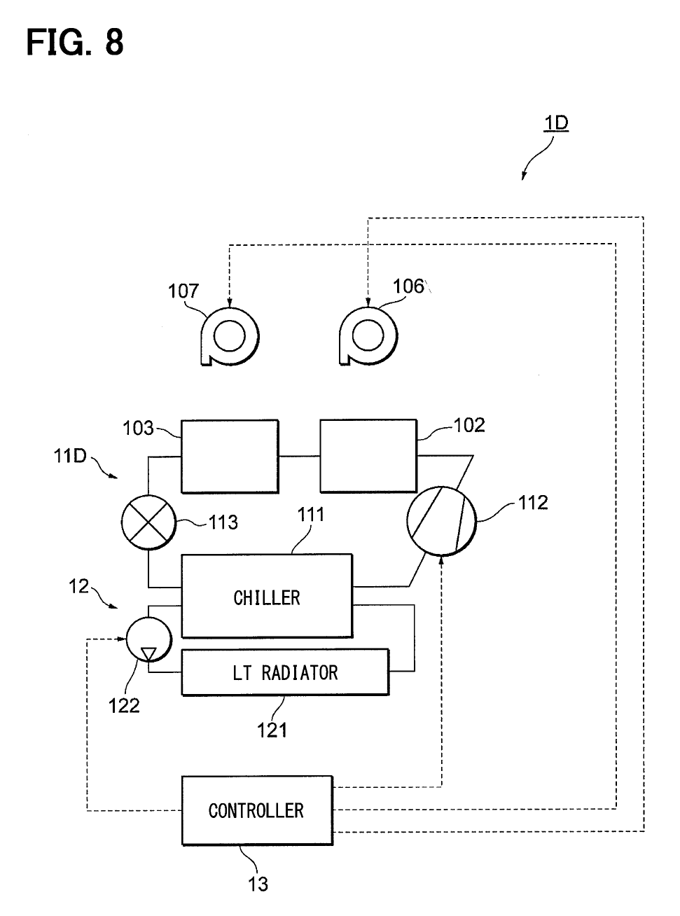

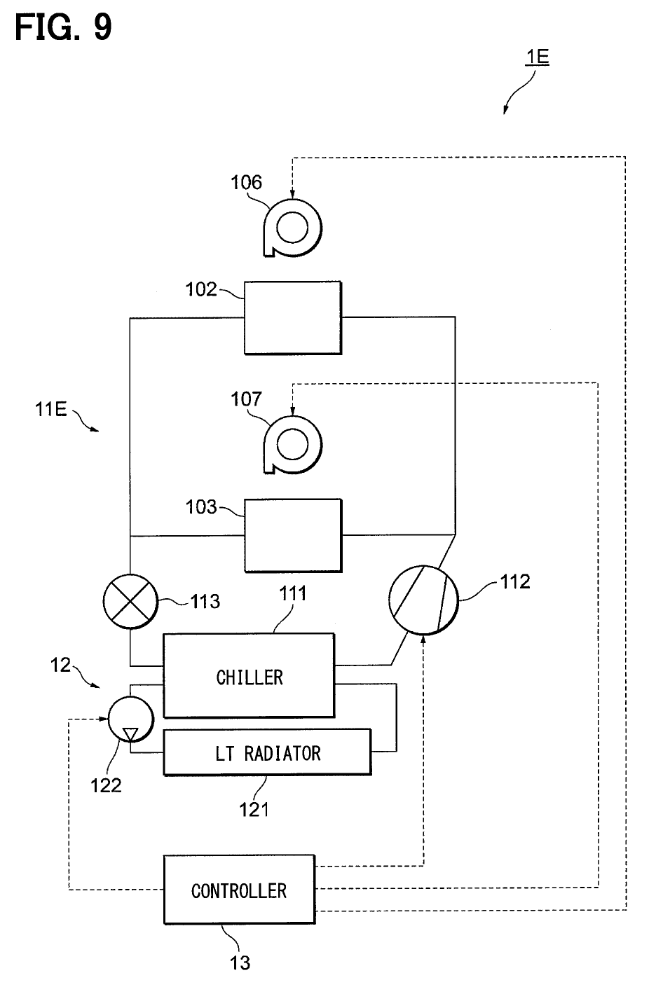

As shown in FIG. 8, the high-temperature side water circuit 10 can be omitted, and a refrigerant circuit 11D can be provided in which the air-conditioning heat exchanger 102 and the battery heat exchanger 103 directly exchange heat with the refrigerant. While referring to FIG. 8, the air-conditioning heat exchanger 102 and the battery heat exchanger 103 are arranged in series, as shown in FIG. 9, a refrigerant circuit 11E can also be provided in which the air-conditioning heat exchanger 102 and the battery heat exchanger 103 are arranged in parallel.

The present embodiments have been described above with reference to specific examples. However, the present disclosure is not limited to these specific examples. Modifications in design can be made to these specific examples by those skilled in the art as appropriate. Such modified examples are included in the scope of the present disclosure as long as they have the features of the present disclosure. The respective elements included in the above-mentioned respective specific examples and their arrangements, conditions, shapes, and the like are not limited to those described as examples and can be modified as appropriate. The combination of the respective elements included in the above-mentioned specific examples can be changed appropriately as long as there is no technical contradiction.

1. A battery warming-up system comprising:
a compressor that compresses and discharges a refrigerant;
an air-conditioning heat exchanger that heats an air-conditioning air flow to be sent to an air-conditioning space by using, as a heat source, a refrigerant discharged from the compressor or a fluid heat-exchanged with the refrigerant discharged from the compressor;
a battery heat exchanger that heats a battery air flow to be sent to a battery by using, as a heat source, a refrigerant discharged from the compressor or a fluid heat-exchanged with the refrigerant discharged from the compressor;
an air-conditioning blower that generates the air-conditioning air flow passing through the air-conditioning heat exchanger;
a battery blower that generates the battery air flow passing through the battery heat exchanger; and
a controller that controls the air-conditioning blower and the battery blower, wherein
the controller executes a battery warming-up mode of controlling at least one of the air-conditioning blower and the battery blower such that an air-side temperature efficiency in the air-conditioning heat exchanger is higher than an air-side temperature efficiency in the battery heat exchanger.

2. The battery warming-up system according to claim 1, wherein
the controller adjusts an air blowing volume of at least one of the air-conditioning blower and the battery blower in the battery warming-up mode such that an air speed of the battery air flow passing through the battery heat exchanger is higher than an air speed of the air-conditioning air flow passing through the air-conditioning heat exchanger.

3. The battery warming-up system according to claim 1, wherein
the controller drives the battery blower from a stage in which a temperature of the refrigerant or the fluid flowing through the battery heat exchanger is lower than a temperature of the refrigerant or the fluid flowing through the air-conditioning heat exchanger in the battery warming-up mode.

4. The battery warming-up system according to claim 1, wherein
the controller controls the battery blower to reduce an air speed of the battery air flow passing through the battery heat exchanger when the controller executes the battery warming-up mode and determines that the battery reaches a target temperature.

5. The battery warming-up system according to claim 1, further comprising:
an air-conditioning adjustment portion that adjusts an amount of the refrigerant or the fluid flowing to the air-conditioning heat exchanger; and
a battery adjustment portion that adjusts an amount of the refrigerant or the fluid flowing to the battery heat exchanger, wherein
the controller is configured to control the air-conditioning blower, the battery blower, the air-conditioning adjustment portion, and the battery adjustment portion, and
the controller executes a battery warming-up mode to control at least one of the air-conditioning blower, the battery blower, the air-conditioning adjustment portion, and the battery adjustment portion such that the air-side temperature efficiency in the air-conditioning heat exchanger is higher than the air-side temperature efficiency in the battery heat exchanger.

6. The battery warming-up system according to claim 5, wherein
the controller adjusts a sending amount of at least one of the air-conditioning adjustment portion and the battery adjustment portion such that an amount of the refrigerant or the fluid sent to the battery heat exchanger is smaller than an amount of the refrigerant or the fluid sent to the air-conditioning heat exchanger in the battery warming-up mode.

7. The battery warming-up system according to claim 5, wherein
the controller controls at least one of the air-conditioning blower, the battery blower, the air-conditioning adjustment portion, and the battery adjustment portion in the battery warming-up mode such that the battery heat exchanger starts to exchange heat from a stage in which a temperature of the refrigerant or the fluid flowing through the battery heat exchanger is lower than a temperature of the refrigerant or the fluid flowing through the air-conditioning heat exchanger.

8. The battery warming-up system according to claim 5, wherein,
the controller executes one or both of a control operation of controlling the battery blower to reduce an air speed of the battery air flow passing through the battery heat exchanger and a control operation of controlling the battery adjustment portion to lessen an amount of the refrigerant or the fluid to be sent to the battery heat exchanger, when the controller executes the battery warming-up mode and determines that the battery reaches a target temperature.

9. The battery warming-up system according to claim 1, wherein,
the controller executes the battery warming-up mode when discharge from the battery is started.

10. The battery warming-up system according to claim 1, wherein,
the controller executes the battery warming-up mode when a temperature of the refrigerant or the fluid is higher than a temperature of the battery.

11. The battery warming-up system according to claim 1, wherein,
the fluid is high-temperature water which is heat-exchanged at a water-refrigerant heat exchanger in a refrigeration cycle, and
the air-conditioning heat exchanger and the battery heat exchanger are arranged in parallel.

12. The battery warming-up system according to claim 1, wherein,
the fluid is high-temperature water that is heat-exchanged at a water-refrigerant heat exchanger in a refrigeration cycle, and
the water-refrigerant heat exchanger, the air-conditioning heat exchanger, and the battery heat exchanger are arranged in series in order from an upstream side in a flow of the fluid.
